(19) United States
(12) Patent Application Publication
(10) Pub. No.: US 2021/0257689 A1
(43) Pub. Date: Aug. 19, 2021

(54) HOLDER STRUCTURE FOR ENERGY STORAGE CELLS AND METHOD FOR MANUFACTURING THE SAME

(71) Applicant: TVS MOTOR COMPANY LIMITED, Chennai (IN)

(72) Inventors: Manish Garg, Chennai (IN); Gavhane Santosh Bhagawat, Chennai (IN); Gundavarapu V S Kumar, Chennai (IN); Mahajan Subhash Sukhdeorao, Chennai (IN); Chithambaram Subramoniam, Chennai (IN); Harne Vinay Chandrakant, Chennai (IN)

(73) Assignee: TVS MOTOR COMPANY LIMITED, Chennai (IN)

(21) Appl. No.: 17/246,326

(22) Filed: Apr. 30, 2021

Related U.S. Application Data
(63) Continuation of application No. PCT/IN2019/050800, filed on Oct. 31, 2019.

(30) Foreign Application Priority Data
Nov. 2, 2018 (IN) 201841041560

(51) Int. Cl. H01M 10/653; C08L 63/00; H01M 50/244; H01M 10/613; H01M 10/6572; H01M 10/625; H01M 50/249; H01M 10/643; H01M 50/213; H01M 10/659; H01M 50/227

(52) U.S. Cl. CPC H01M 10/653; C08L 63/00; H01M 50/244; H01M 10/613; H01M 10/6572; H01M 2220/20; H01M 50/249; H01M 10/643; H01M 50/213; H01M 10/659; H01M 50/227; H01M 10/625

(57) ABSTRACT

An energy storage device includes one or more energy storage cells and at least one holder structure adapted to store at least one energy storage cell of said one or more energy storage cells. Said at least one holder structure includes a composition containing, in weight percent, of a predetermined amount of at least one thermosettable material and an effective amount of at least one curing agent and a predetermined amount of a phase change material. A method of manufacturing said at least holder structure provides high conductivity, high heat absorbing and dissipating capability, improved cooling mechanism, high thermal conductivity and characteristics resulting in minimal risk of electric short circuit between the one or more energy storage cells.

### TECHNICAL FIELD

The present subject matter relates to an energy storage device. More particularly, the present subject matter relates to at least one holder structure for energy storage cells and method for manufacturing the same.

### BACKGROUND

Conventionally, lead-acid batteries are a useful power source for starter motors for internal combustion engines. However, their low energy density, and their inability to dissipate heat adequately, makes them an impractical power source for an electric vehicle. Particularly, an electric vehicle using lead acid batteries has a short range before requiring recharge and contain toxic materials. In addition, electric vehicles using lead-acid batteries have sluggish acceleration, poor tolerance to deep discharge, and low battery lifetime. Thus, energy storage packs that contain lithium ion batteries are increasingly popular with automotive applications and various commercial electronic devices because they are rechargeable, lightweight and comprises high energy density. However, storing and operating the energy storage pack with lithium ion batteries at an optimal operating temperature is very important to allow the battery to maintain a charge for an extended period of time and allow faster charging rates.

A known battery pack comprises a battery unit composed of a one or more energy storage cells electrically connected with one another by either series or parallel connection, or a combination of series connection and parallel connection. Typically, the battery pack comprises one or more holder structure made up of materials exhibiting excellent thermal conductivity. The holder structure for such battery packs are adapted for holding one or more energy storage cells. However, during operative condition of the battery pack, the current flows through the batteries to power the vehicle. As current is drawn off the batteries, heat is generated within the battery pack. Also, during charging of the battery pack, heat is likewise accumulated during the charging process. The heat generated during discharge of the batteries as well as charging of the batteries, leads to increased temperatures causing a severe effect on the life expectancy and performance of the batteries. Thus, when one or more energy storage cell goes into thermal runaway, either through violation of safe temperature limit, manufacturing process induced cell short circuit, over charge or depending on the type of material used for manufacturing the holder structure for the cells, the amount of energy released may cause adjacent energy storage cells to also go into thermal runaway, this chain reaction can catastrophically destroy the battery pack.

### BRIEF DESCRIPTION OF THE DRAWINGS

The detailed description is described with reference to the accompanying figures. The same numbers are used throughout the drawings to reference like features and components.

FIG. 1 is a perspective view of at least one energy storage pack, as per one embodiment of the present invention.

FIG. 2 is an exploded view of said at least one energy storage pack, as per one embodiment of the present invention.

FIG. 3 is an exploded view of said at least one energy storage pack including at least one holder structure, as per one embodiment of the present invention.

FIG. 4 is a perspective view of said at least one holder structure of said at least one energy storage pack of FIG. 3, as per one embodiment of the present invention.

FIG. 5 is an exploded view of said at least one holder structure and one or more energy storage cells of said at least one energy storage pack of FIG. 4, as per one embodiment of the present invention.

FIG. 6 is a perspective view of said at least one holder structure with said one or more energy storage cells contained therein, as per one embodiment of the present invention.

FIG. 7 illustrates the method of manufacturing said at least one holder structure as per one embodiment of the present invention.

### DETAILED DESCRIPTION

An existing energy storage device comprises at least one holder structure configured to hold one or more energy storage cells therein. Typically, said at least one holder structure is made up of a rigid member in the form of a metal of high conductivity. In such energy storage device, cooling structures in the form of fins are formed in at least a portion of sidewalls of said at least one holder structure. Thus, the heat generated during charging and discharging process of said one or more the energy storage cells is effectively dissipated through said cooling structures. However, since said at least one holder structure is made up of metal, preferably an aluminum, thus due to the direct contact of said metal and said one or more energy storage cells the heat generated during charging and discharging process of said one or more the energy storage cells results in electric short circuit between cells and other one or more electrical parts including interconnect plates, thereby damaging the energy storage device because of thermal impact to adjacent cells and hence the inception of a chain reaction.

In a known structure for supporting said one or more energy storage cells in the energy storage device, said at least one holder structure is made up of a phase change material (PCM). As the latent heat of fusion of the phase change material (PCM) is high, it can absorb significant amount of heat without much rise in temperature. During charging and discharging of said energy storage device, the phase change material absorbs heat generated by the one or more energy storage cells and hence changes its state from solid to liquid. However, due to low thermal conductivity and poor heat dissipating properties, said phase change material takes long time to regain original solid state, with a resulting difficulty in providing immediate charging to said energy storage device. Thus, in order to improve the thermal conductivity of the phase change material (PCM), one or more thermal conductivity enhancer additives, example: carbon fibres, graphite, aluminum foam etc., are added to the phase change material (PCM). Due to electrically conductive property of the additives, the phase change material with said additives loses its property of being electrically isolative which results in electric short circuiting within the energy storage device, thereby making said holder structure unsuitable for storing said one or more energy storage cells therein.

In another existing energy storage device, said at least one holder structure is made up of an epoxy resin material due to its better thermal conductivity. Improved cooling mechanism for said one or more energy storage cells, improves heat dissipation properties and with characteristics of mitigating risk of causing short circuits between cells in said energy storage device. However, the epoxy resin has poor heat absorbing capability and hence making it unsuitable for designing said at least one holder structure of the epoxy resin material.

With the above objectives in view, the present invention provides an improved at least one holder structure for the energy storage device that has high thermal conductivity, high heat absorbing and dissipating capability, improved cooling mechanism and that results in minimal risk of electric short circuit between cells. Furthermore, said improved at least one holder structure for said energy storage device comprises an improved thermal and electrical properties that mitigates the thermal runway and protects the energy storage device from damage. More particularly, but not exclusively, this invention relates to a novel and improved at least one holder structure of the energy storage device for mitigation of a thermal runaway event in the energy storage device including a one or more energy storage cells. As per one embodiment, the present invention concerns improvements relating to said at least one holder structure adapted for holding said one or more energy storage cells in the secured position, to within accepted tolerances, even during charging and discharging of said one or more energy storage cells.

According to one embodiment of the present invention, said at least one energy storage device comprises one or more energy storage cells and at least one holder structure adapted to store at least one energy storage cells of said one or more energy storage cells. In one embodiment, said at least one holder structure adapted to support said one or more energy storage cells comprises a composition containing an intimate mixture of at least one thermosetting material in a predetermined amount by weight percent and an effective amount of at least one curing agent to cure said composition of said at least one holder structure. In one embodiment, a phase change material in a predetermined amount by weight percent is added to said mixture of the composition of said at least one holder structure. In another embodiment, a thermal conductivity enhancer along with said phase change material in a predetermined amount by weight percent is added to said mixture of the composition of said at least one holder structure to improve the thermal conductivity of said at least one holder structure. As per another embodiment, said thermal conductivity enhancer is an electrically non-conductive material. Further, as per another embodiment, said thermal conductivity enhancer includes ceramic, carbon fibres, graphite, and aluminum foam, etc. More particularly, as per one embodiment of the present invention, said at least one thermosetting material and said at least one curing agent are stirred together in at least one supporting structure for a first predetermined period of time prior to the adding of said phase change material to said mixture of said at least one holder structure. The composition of said at least one holder structure with said at least one thermosetting material, said at least one curing agent and said phase change material are stirred in said at least one supporting structure for a second predetermined period of time to form a homogenous composition. As per an embodiment, each of the first predetermined period of time and the second predetermined period of time ranges from about 20 minutes to about 90 minutes. As per one embodiment, said at least one thermosetting material is a thermally conductive liquid epoxy resin. The liquid epoxy resin is one of Bisphenol F resin, Bisphenol A resin, and Novolac, In one embodiment, said at least one thermosetting material is in the predetermined amount of at least 5% by weight of said mixture and said phase change material in a granulated form is taken in the predetermined amount of at least 5% by weight of said mixture. In one embodiment, said at least one curing agent is in an effective amount of at least 1% by weight of said composition of said mixture. In an embodiment, the phase change material is one of paraffin-based waxes and the curing agent is selected from a group consisting of aliphatic amines, polyamides, and aromatic amines In another embodiment, said thermal conductivity enhancer is an electrically non-conductive material in a predetermined amount of at least 1% to at least 5% by weight of the mixture.

As per one embodiment of the present invention, said at least one holder structure of said at least one energy storage device includes one or more receiving portions formed integrally with at least a portion thereof. In one embodiment, said one or more receiving portions are configured to hold one or more energy storage cells. The one or more receiving portions comprise a radial diameter greater than the dimension of said one or more energy storage cells. As per one embodiment, said one or more energy storage cells includes a lithium ion battery configured to be secured in said one or more receiving portions in one or more configuration such as series and parallel combination.

The present invention describes a method of manufacturing said at least one holder structure. As per one embodiment, said method comprising steps of providing a composition including a mixture of at least one thermosetting material and at least one curing agent in at least one supporting structure to cure said composition, adding the phase change material to said mixture after said at least one thermosetting material and the phase change material contained therein are stirred together for a first predetermined period of time, curing the thermosetting material at a predetermined temperature to form said at least one holder structure, machining said composition contained in said at least one supporting structure to derive said at least one holder structure and disposing at least one energy storage cell of said one or more energy storage cells in one or more receiving portions formed integrally in at least a portion of said at least one holder structure. As per one embodiment, said composition is cured at the predetermined temperature being less than the melting temperature of said phase change material to derive said at least one holder structure. In an embodiment, the predetermined temperature is room temperature or an elevated of about 120° C. In an embodiment, the first predetermined period of time ranges from about 20 minutes to about 90 minutes. In one embodiment, said at least one holder structure is a thermally conducting structure. As per one embodiment said at least one supporting structure includes at least one container adapted to contain said composition to form said at least one holder structure. In one embodiment, said at least one container is made up of a resin material. In another embodiment, said at least one container is made up of a rigid member including a metal. As per another embodiment of the present invention, a thermal conductivity enhancer along with said phase change material in a predetermined amount by weight percent is added to said mixture of the composition of said at least one holder structure to improve the thermal conductivity of said at least one holder structure. In an embodiment, the composition of said at least one holder structure includes said thermal conductivity enhancer in the predetermined amount of at least 1% to at least 5% by weight. The thermal conductivity enhancer is, for example, ceramic material, carbon fibers, graphite, aluminum foam, etc.

Further, as per one embodiment of the present invention, at least one energy storage pack includes an outer casing structure to accommodate said at least one energy storage device therein. The outer casing structure for said at least one energy storage pack includes a pair of left and right cover members. In one embodiment of the present invention, at least one cooling member in the form of a Peltier device is provided between said at least one energy storage device and said at least one holder structure of said at least one energy pack.

Various other features and advantages of the invention are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number. With reference to the accompanying drawings, wherein the same reference numerals will be used to identify the same or similar elements throughout the several views. It should be noted that the drawings should be viewed in the direction of orientation of the reference numerals.

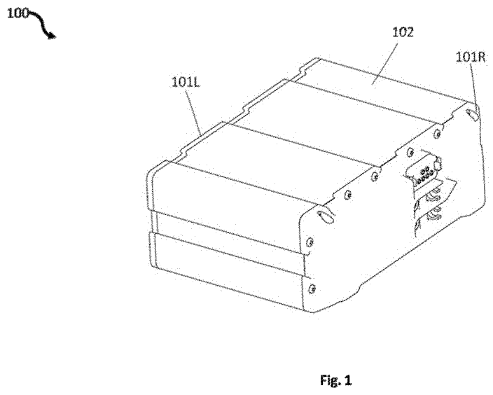

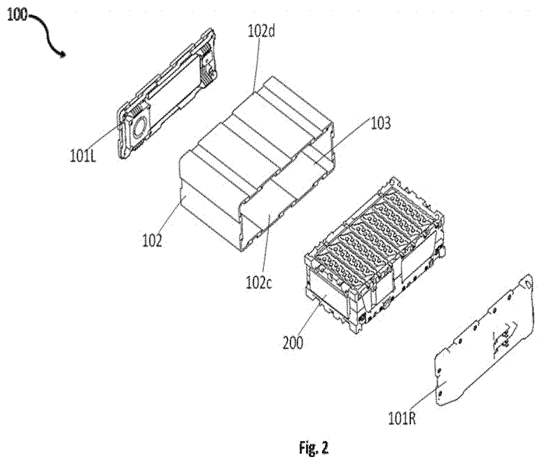

FIG. 1 is a perspective view of said at least one energy storage pack (100), as per one embodiment of the present invention. In one embodiment, said at least one energy storage pack (100) includes an outer casing structure (102) to accommodate the one or more energy storage devices (200) (shown in FIG. 2) therein. The outer casing structure (102) for said at least one energy storage pack (100) includes a pair of left and right cover members (101L) (101R).

FIG. 2 is an exploded view of said at least one energy storage pack (100), as per one embodiment of the present invention. In one embodiment, said outer casing structure (102) adapted to accommodate said at least one energy storage device (200) therein comprises the pair of left and right cover members (101L) (101R) adapted to cover said at least one open side (102c), (102d) of said at least one energy storage pack (100). In one embodiment, said outer casing is adapted to accommodate at least one energy storage device (200) therein.

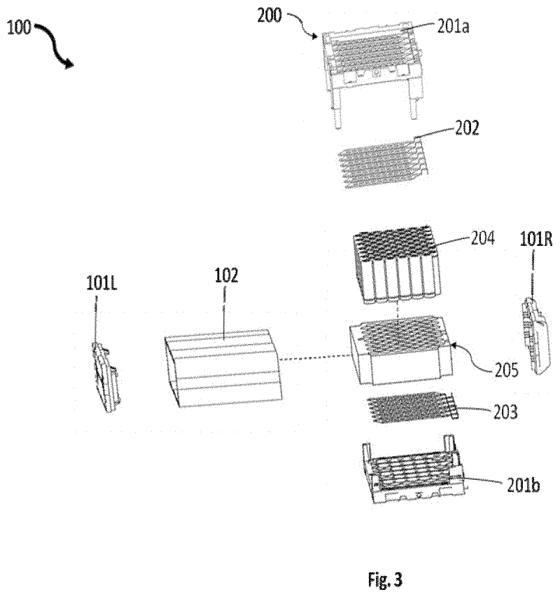

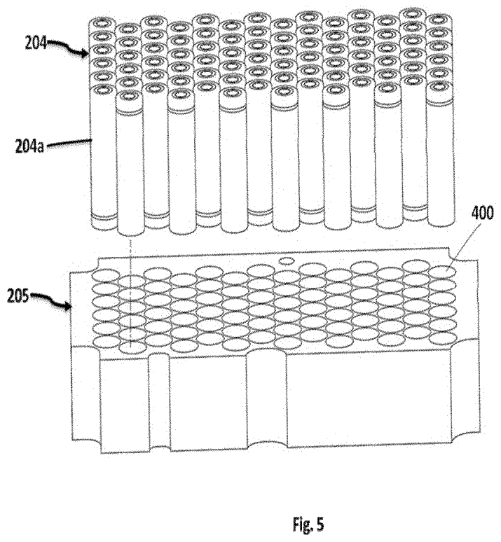

FIG. 3 is an exploded view of the energy storage pack (100) including at least one holder structure (205), as per one embodiment of the present invention. As per one embodiment of the present invention, said at least one energy storage device (200) of said at least one energy storage pack (100) comprises of the one or more energy storage cells (204) and said at least one holder structure (205) adapted to store said one or more energy storage cells (204a) (shown in FIG. 5) of said one or more energy storage cells (204). In one embodiment, said composition of said at least one holder structure (205) comprises an intimate mixture of said at least one thermosetting material in the predetermined amount of said at least 5% by weight of said mixture and the effective amount of said at least one curing agent to cure the composition of said at least one holder structure. As per an embodiment, the predetermined amount of said at least one curing agent is at least 1% by weight of the intimate mixture. As per one embodiment, said at least one thermosetting material and said at least one curing agent are stirred together to the first predetermined period of time, for example, about 20 minutes to about 90 minutes in said at least one supporting structure, prior of adding said the phase change material in the predetermined amount of said at least 5% by weight to said mixture of the composition; of said at least one holder structure (205). In an embodiment, a thermal conductivity enhancer is added in a predetermined amount of at least 1% to at least 5% weight of the mixture, along with the phase change material to the mixture. In one embodiment, said one or more energy storage cells (204) are electrically connected with each other through one or more interconnect plates (202), (203). As per one embodiment, said one or more interconnect plates (202), (203) electrically connect said one or more energy storage cells (204) with each other and to a battery management system (BMS) (not shown) through an upper holder member (201a) and a lower holder member (201b). In one embodiment, said at least an upper portion of said one or more energy storage cells (204) are electrically connected through said one or more interconnect plates (202), (204) on said upper holder member (201a) and said lower holder (201b) to establish an electrical connection between said one or more energy storage cells and said battery management system (BMS) (not shown) of said at least one energy storage device (200).

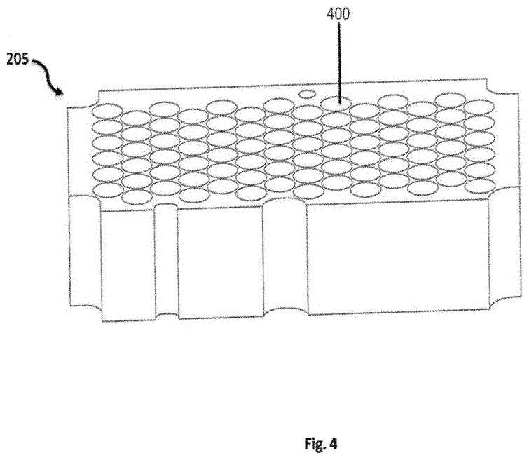

FIG. 4 is a perspective view of said at least one holder structure (205) of the energy storage pack (100) of FIG. 3, as per one embodiment of the present invention. In one embodiment of the present invention, said at least one holder structure (205) of said at least one energy storage device (200) is adapted to hold. one or more energy storage cells (204) (shown in FIG. 5) of said one or more energy storage cells (204). As per one embodiment, said at least one holder structure (205) comprises said composition containing said at least one thermosetting material in the form of the liquid epoxy resin, the phase change material in the granulated form and said at least one curing agent. The liquid epoxy resin is, for example, Bisphenol F resin, Bisphenol A resin, Novolac, etc. The phase change material is, for example, paraffin-based waxes. The curing agent is, for example, aliphatic amines, polyamides, aromatic amines, etc.

Further in FIG. 4, as per one embodiment, said at least one holder structure (205) includes said one or more receiving portions (400) formed integrally in said at least a portion thereof. As per one embodiment, said one or more receiving portions are dimensioned to receive said at least a portion of said one or more energy storage cells (204) (shown in FIG. 5) therein. Further, in one embodiment, said one or more energy storage cells (204) (shown in FIG. 5) includes a lithium ion battery configured to be secured in said one or more receiving portions (400) in one or more configuration. The one or more receiving portions (400) comprises a radial diameter slightly greater than the dimension of said one or more energy storage cells (204a) (shown in FIG. 5) of said one or more energy storage cells (204) (shown in FIG. 5).

FIG. 5 is an exploded view of said at least one holder structure (205) and said one or more energy storage cells (204) of the energy storage pack (100) of

FIG. 4, as per one embodiment of the present invention. In one embodiment, said one or more receiving portions (400) are configured to include radial diameter slightly greater than the dimension of said at least one energy storage cell (204a) of said one or more energy storage cells (204) such that said one or more energy storage cells (204a) is secured in said at least one holder structure (205) of said at least one energy storage device (200) of said at least one energy storage pack (100).

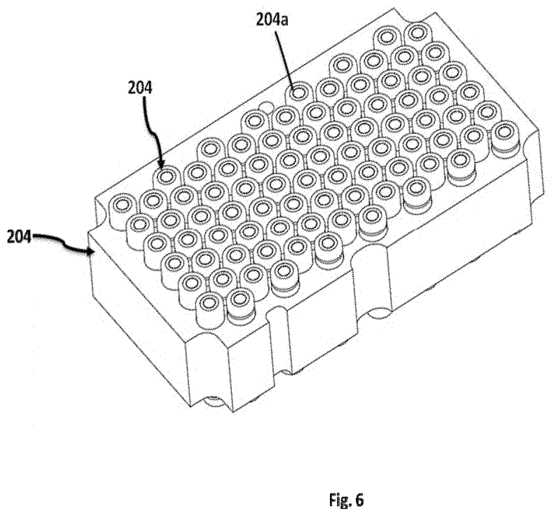

FIG. 6 is a perspective view of said at least one holder structure (205) with said one or more energy storage cells (204) contained therein, as per one embodiment of the present invention. As per one embodiment, said one or more energy storage cells (204) are secured in position in said at least one holder structure (205) of said at least one energy storage device (200) (shown in FIG. 2). In one embodiment of the present invention, said at least one energy storage cell (204a) of the one or more energy storage cells (204) are disposed in one or more configuration including series and parallel configuration.

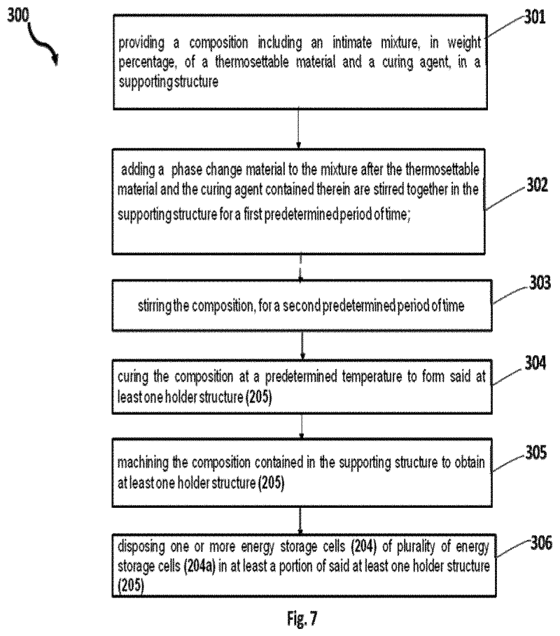

FIG. 7 illustrates the method of manufacturing said at least one holder structure as per one embodiment of the present invention. In one embodiment, the method (300) of manufacturing said at least one holder structure (205) comprising step 1 (301) of providing a composition including an intimate mixture, in weight percent, of at least one thermosetting material and a phase change material in at least one supporting structure, step 2 (302) of adding a phase change material to said mixture when said at least one thermosetting material and said at least one curing agent contained therein are stirred together in said at least one supporting structure for a first predetermined period of time, step 3 (303) of stirring said composition containing said at least one thermosetting material, said at least one curing agent and the phase change material, for a second predetermined period of time, for example, about 20 minutes to about 90 minutes, step 4 (304) of molding the composition at an elevated temperature of about 120° C. to form said at least one holder structure (205) and step 5 (305) of machining said composition contained in said at least one supporting structure to obtain said at least one holder structure (205).

### Exemplary Embodiments of the Method

An embodiment of the at least one holder structure (205) of the present disclosure was prepared by the following process steps: the thermosetting material is an liquid epoxy resin, for example, a Bisphenol F resin and the curing agent is for example, an aliphatic amine About 94% by weight of the thermosetting material is mixed with about 1% by weight of the curing agent in at least one supporting structure. The mixture is stirred for about 40 minutes and then 5% by weight of phase change material, such as, the paraffin wax is added to the stirred mixture. The mixture of the thermosetting material, the curing agent, and the phase change material are stirred together for another 40 minutes. The stirred mixture is allowed to cure at room temperature (35-40° C.) for about 24-48 hours in the supporting structure. The cured composition of the mixture in the supporting structure is machined, such as, milled to form the holder structure (205).

Another embodiment of the at least one holder structure of the present disclosure was prepared by the following process steps: the thermosetting material is an liquid epoxy resin, for example, a Bisphenol F resin and the curing agent is for example, an aliphatic amine About 87% by weight of the thermosetting material is mixed with about 3% by weight of the curing agent in at least one supporting structure. The mixture is stirred for about 40 minutes and then 5% by weight of phase change material, such as, the paraffin wax is added to the stirred mixture. Further, 3% by weight of a thermal conductivity enhancer, such as, graphite is added along with the phase change material. The mixture of the thermosetting material, the curing agent, the phase change material, and the thermal conductivity enhancer are stirred together for another 40 minutes. The stirred mixture is allowed to cure at predetermined temperature (up to 120° C.) for less than 24 hours in the supporting structure. The cured composition of the mixture in the supporting structure is machined to form the holder structure (205).

Advantageously, an improved at least one holder structure for said at least one energy device provides for a way of thermally balancing said one or more energy storage cells of said at least one energy storage unit thus maximizing the longevity, efficiency and power. Further, it is advantageous to provide said improved at least one holder structure comprising the composition of said at least one thermosetting material, said phase change material in the granulated form and said at least one curing agent such that said at least one holder structure, when derived through one or more steps of the method of manufacturing, said at least one holder structure has high conductivity, high heat absorbing and dissipating capability, improved cooling mechanism, high thermal conductivity and characteristics of mitigating the risk of electric short circuit between cells. Thus, as per one embodiment, the improved at least one holder structure with one or more improved thermal and electrical properties ensures continuous recharging of said at least one energy storage device with improved performance

Improvements and modifications may be incorporated herein without deviating from the scope of the invention.

We claim:

1. A holder structure for energy storage cells of an energy storage device, said holder structure having a composition comprising:
a mixture of at least one thermosetting material in a predetermined amount by weight percent and at least one curing agent in an effective amount to cure said composition; and
a phase change material in a predetermined amount by weight percent;
said at least one thermosetting material and said at least one curing agent are stirred together in at least one supporting structure for a first predetermined period of time, prior to adding said phase change material in the predetermined amount by weight percent to said mixture.

2. The holder structure as claimed in claim 1,
wherein said at least one thermosetting material is a thermally conductive liquid epoxy resin,
wherein said at least one thermosetting material is in the predetermined amount of at least 5% by weight of said mixture,
wherein said phase change material in a granulated form is taken in the predetermined amount of at least 5% by weight of said mixture,
wherein said at least one curing agent is taken in the effective amount of at least 1% by weight of said mixture, and
wherein said mixture of said at least one thermosetting material and said at least one curing agent are stirred in said at least one supporting structure after addition of said at least one phase change material thereto, for a second predetermined period of time, to form a homogenous composition.

3. The holder structure as claimed in claim 2,
wherein the liquid epoxy resin is one of Bisphenol F resin, Bisphenol A resin, and Novolac,
wherein the curing agent is selected from a group consisting of aliphatic amines, polyamides, and aromatic amines, and
wherein the phase change material is one of paraffin-based waxes, and,
wherein the second predetermined period of time ranges from about 20 minutes to about 90 minutes.

4. The holder structure as claimed in claim 1, wherein the first predetermined period of time ranges from about 20 minutes to about 90 minutes.

5. A holder structure for energy storage cells of an energy storage device, said holder structure having a composition comprising:
a mixture of at least one thermosetting material in a predetermined amount by weight percent and at least one curing agent in an effective amount to cure said composition of said at least one holder structure;
a phase change material in a predetermined amount by weight percent; and
a thermal conductivity enhancer in a predetermined amount by weight percent;
said at least one thermosetting material and said at least one curing agent are stirred together in at least one supporting structure for a first predetermined period of time, prior to adding said phase change material and said thermal conductivity enhancer in the predetermined amount by weight percent to said mixture.

6. The holder structure as claimed in claim 5,
wherein said at least one thermosetting material is a thermally conductive liquid epoxy resin,
wherein said thermal conductivity enhancer is an electrically non-conductive material,
wherein said at least one thermosetting material is in the predetermined amount of at least 5% by weight of said mixture,
wherein said phase change material in a granulated form is taken in the predetermined amount of at least 5% by weight of said mixture,
wherein said at least one curing agent is taken in the effective amount of at least 1% by weight,
wherein said thermal conductivity enhancer is taken in the predetermined amount of at least 1% to at least 5% by weight, and
wherein said mixture of said at least one thermosetting material and said at least one curing agent are stirred in said at least one supporting structure after addition of said phase change material and said thermal conductivity enhancer thereto, for a second predetermined period of time, to form a homogenous composition.

7. The holder structure as claimed in claim 6,
wherein the thermal conductivity enhancer is one of ceramic material, carbon fibres, graphite, and aluminium foam,
wherein the liquid epoxy resin is one of Bisphenol F resin, Bisphenol A resin, and Novolac,
wherein the curing agent is selected from a group consisting of aliphatic amines, polyamides, and aromatic amines,
wherein the phase change material is one of paraffin-based waxes, and
wherein the second predetermined period of time ranges from about 20 minutes to about 90 minutes.

8. The holder structure as claimed in claim 5, wherein the first predetermined period of time ranges from about 20 minutes to about 90 minutes.

9. An energy storage device comprising:
one or more energy storage cells; and
at least one holder structure adapted to store at least one energy storage cell of said one or more energy storage cells,
wherein said at least one holder structure comprises a composition containing a mixture, in weight percent, of a predetermined amount of at least one thermosetting material and an effective amount of at least one curing agent, and
wherein said at least one thermosetting material and said at least one curing agent are stirred together in at least one supporting structure for a first predetermined period of time, prior to adding said phase change material in the predetermined amount by weight percent to said mixture of said at least one holder structure.

10. The energy storage device as claimed in claim 9, wherein said at least one holder structure is accommodated in an outer casing structure with at least one cooling member in the form of a Peltier device being provided therebetween.

11. An energy storage device comprising:
one or more energy storage cells; and
at least one holder structure adapted to store at least one energy storage cell of said one or more energy storage cells,
wherein said at least one holder structure comprises a composition containing an intimate mixture, in weight percent, of a predetermined amount of at least one thermosetting material and an effective amount of at least one curing agent; and
wherein said at least one thermosetting material and said at least one curing agent are stirred together in at least one supporting structure, for a first predetermined period of time, prior to adding said phase change material and said thermal conductivity enhancer in the predetermined amount by weight percent to said mixture of said at least one holder structure.

12. The energy storage device as claimed in claim 11, wherein said at least one holder structure is accommodated in an outer casing structure with at least one cooling member in the form of a peltier device being provided therebetween.

13. A method of manufacturing at least one holder structure, said method comprising steps of:
providing a composition including an intimate mixture in at least one supporting structure, said mixture comprising in weight percent, of at least one thermosetting material and at least one curing agent,
adding a phase change material to said mixture after said at least one thermosetting material and said at least one curing agent contained therein are stirred together in at least one supporting structure for a first predetermined period of time;
stirring said composition containing said at least one thermosetting material, said at least one curing agent and the phase change material, for a second predetermined period of time;
curing the composition at a predetermined temperature to form said at least one holder structure; and
machining said composition contained in said at least one supporting structure to obtain said at least one holder structure.

14. The method as claimed in claim 13,
wherein said composition of said at least one holder structure includes said at least one thermosetting material in the predetermined amount of at least 5% by weight of said mixture,
wherein said composition of said at least one holder structure includes said phase change material in the predetermined amount of at least 5% by weight of said mixture,
wherein said composition of said at least one holder structure includes said at least one curing agent in the effective amount of at least 1% by weight,
wherein said at least one holder structure is a thermally conducting structure,
wherein said at least one thermosetting material is a thermally conductive liquid epoxy resin, and
wherein said composition is cured at the predetermined temperature being less than the melting temperature of said phase change material to derive said at least one holder structure.

15. The method as claimed in claim 14,
wherein said liquid epoxy resin is one of Bisphenol F resin, Bisphenol A resin, and Novolac,
wherein said at least one curing agent is selected from a group consisting of aliphatic amines, polyamides, and aromatic amines, and
wherein said phase change material is one of paraffin-based waxes.

16. The method as claimed in claim 13,
wherein each of the first predetermined period of time and the second predetermined period of time ranges from about 20 minutes to about 90 minutes, and
wherein the predetermined temperature is one of a room temperature and an elevated of about 120° C.

17. A method of manufacturing at least one holder structure, said method comprising steps of:
providing a composition including an intimate mixture in at least one supporting structure, said mixture comprising in weight percent, of at least one thermosetting material and at least one curing agent,
adding a phase change material and a thermal conductivity enhancer to said mixture after said at least one thermosetting material and said at least one curing agent contained therein are stirred together in at least one supporting structure for a first predetermined period of time;
stirring said composition containing said at least one thermosetting material, said at least one curing agent and the phase change material, for a second predetermined period of time;
curing the composition at a predetermined temperature to form said at least one holder structure;
machining said composition contained in said at least one supporting structure to obtain said at least one holder structure.

18. The method as claimed in claim 17,
wherein said composition of said at least one holder structure includes said at least one thermosetting material in the predetermined amount of at least 5% by weight of said mixture,
wherein said composition of said at least one holder structure includes said phase change material in the predetermined amount of at least 5% by weight of said mixture, and
wherein said composition of said at least one holder structure includes said at least one curing agent in the effective amount of at least 1% by weight.
wherein said at least one holder structure is a thermally conducting structure,
wherein said at least one thermosetting material is a thermally conductive liquid epoxy resin,
wherein said thermal conductivity enhancer is an electrically non-conductive material,
wherein said composition of said at least one holder structure includes said thermal conductivity enhancer in the predetermined amount of at least 1% to at least 5% by weight, and
wherein said composition is cured at the predetermined temperature being less than the melting temperature of said phase change material to derive said at least one holder structure.

19. The method as claimed in claim 18,
wherein the thermal conductivity enhancer is one of ceramic material, carbon fibres, graphite, and aluminium foam,
wherein said liquid epoxy resin is one of Bisphenol F resin, Bisphenol A resin, and Novolac,
wherein said at least one curing agent is selected from a group consisting of aliphatic amines, polyamides, and aromatic amines, and
wherein said phase change material is one of paraffin-based waxes.

20. The method as claimed in claim 17,
wherein each of the first predetermined period of time and the second predetermined period of time ranges from about 20 minutes to about 90 minutes, and
wherein the predetermined temperature is one of a room temperature and an elevated of about 120° C.
